(19) United States
(12) Patent Application Publication
(10) Pub. No.: US 2026/0029100 A1
(43) Pub. Date: Jan. 29, 2026

(54) VEHICLE HEADLAMP

(71) Applicant: KOITO MANUFACTURING CO., LTD., Tokyo (JP)

(72) Inventors: Takeshi HORIBA, Shizuoka (JP); Tomoharu MOCHIZUKI, Shizuoka (JP); Takayuki OCHIAI, Shizuoka (JP); Toyohisa TOKUDOME, Shizuoka (JP)

(21) Appl. No.: 19/344,536

(22) Filed: Sep. 30, 2025

Related U.S. Application Data
(63) Continuation of application No. PCT/JP2024/009739, filed on Mar. 13, 2024.

(30) Foreign Application Priority Data
Apr. 12, 2023 (JP) 2023-065059
Apr. 12, 2023 (JP) 2023-065060

(51) Int. Cl. F21S 41/32; F21S 41/153; F21S 41/43; F21S 41/663; F21W 102/155; F21W 102/16

(52) U.S. Cl. CPC F21S 41/321; F21S 41/153; F21S 41/43; F21S 41/663; F21W 2102/155; F21W 2102/16

(57) ABSTRACT

A vehicle headlamp includes a first optical member that has a first cutoff line and forms a first light distribution pattern by irradiating at least a region below the first cutoff line with light, and a second optical member that has a second cutoff line, which is more blurred than the first cutoff line, and forms a second light distribution pattern emitted to a position overlapping at least a portion of the first cutoff line. The second optical member includes a second light source and a second reflector having a parabolic shape that reflects light emitted from the second light source forward of the vehicle headlamp.

### CROSS REFERENCE TO RELATED APPLICATIONS

This application is a continuation application of International Patent Application No. PCT/JP2024/009739, filed on Mar. 13, 2024, which claims priority from Japanese Patent Application Nos. 2023-065059 and 2023-065060, filed on Apr. 12, 2023, with the Japan Patent Office, respectively, the disclosures of which are incorporated herein in their entireties by reference.

### TECHNICAL FIELD

The present disclosure relates to a vehicle headlamp.

### BACKGROUND

Japanese Patent Laid-Open Publication No. 2008-262755 discloses a vehicle lighting device capable of achieving a low beam light distribution pattern that is easy to see by suitably blurring the bright-dark boundary of a cutoff line while preventing the G-value from increasing beyond the statutory reference value.

### SUMMARY

There is a demand for forming a low beam light distribution pattern that is easy to see by blurring the cutoff line, as disclosed in Japanese Patent Laid-Open Publication No. 2008-262755, while there is also a demand for simplifying the configuration of a vehicle headlamp as much as possible to reduce manufacturing costs. For example, there is a demand for a vehicle headlamp that provides both high commercial value and affordability.

Further, a light distribution pattern with a sharp cutoff line is required, in order to avoid causing glare to oncoming or preceding vehicles. In the meantime, as in Japanese Patent Laid-Open Publication No. 2008-262755, there are cases where a light distribution pattern with a blurred cutoff line is required to enhance the driver's long-distance visibility.

The present disclosure provides a vehicle headlamp capable of forming a light distribution pattern with enhanced visibility at a low cost.

Further, the present disclosure provides a vehicle headlamp with a relatively simple configuration that is capable of implementing both a light distribution pattern having a sharp cutoff line and a light distribution pattern having a blurred cutoff line.

A vehicle headlamp according to one aspect of the present disclosure includes a first optical member that has a first cutoff line and forms a first light distribution pattern by irradiating at least a region below the first cutoff line with light, and a second optical member that has a second cutoff line that is more blurred than the first cutoff line, and forms a second light distribution pattern that is emitted to a position overlapping at least a portion of the first cutoff line. The second optical member includes a second light source and a second reflector having a parabolic shape that reflects light emitted from the second light source forward of the vehicle headlamp.

According to the above configuration, the second optical member has the second cutoff line that is more blurred than the first cutoff line, and forms the second light distribution pattern that is emitted to the position overlapping at least a portion of the first cutoff line. The second optical member includes the second light source and the second reflector having a parabolic shape that reflects light emitted from the second light source forward of the vehicle headlamp. The second optical member is more likely to form a light distribution pattern having a blurred cutoff line, compared to the cutoff line of a light distribution pattern formed, for example, by a projector ellipsoid system (PES)-type optical member at a low cost. The vehicle headlamp of the above configuration including the second optical member may form a light distribution pattern with enhanced visibility at a low cost.

Further, a vehicle headlamp according to one aspect of the present disclosure includes a first optical member that has a first cutoff line and forms a first light distribution pattern by irradiating at least a region below the first cutoff line with light, and a second optical member that has a second cutoff line that is more blurred than the first cutoff line, and forms a second light distribution pattern that is emitted to a position overlapping at least a portion of the first cutoff line. The second optical member includes a second light source and a second reflector having a parabolic shape that reflects light emitted from the second light source forward of the vehicle headlamp. The first optical member and the second optical member are arranged in a height direction of a vehicle on which the vehicle headlamp is mounted. The second optical member is arranged above the first optical member.

According to the above configuration, it is more likely to form a light distribution pattern having a blurred cutoff line, compared to the cutoff line of a light distribution pattern formed by a PES-type optical member, and the configuration may also be achieved at a low cost. Accordingly, the vehicle headlamp of the above configuration including the second optical member may form a light distribution pattern with enhanced visibility at a low cost. Further, the first optical member and the second optical member are arranged in the height direction of the vehicle on which the vehicle is mounted, and the second optical member is located above the first optical member. When the vehicle headlamp is mounted on a vehicle with a relatively high attachment position of the vehicle headlamp, such as a pickup truck, the vehicle headlamp may form a light distribution pattern with enhanced visibility by simply emitting light in a linear path from the second optical member, and also has an aesthetically pleasing design.

Further, a vehicle headlamp according to one aspect of the present disclosure includes a reflector having a parabolic shape, a third light source that emits a fourth light distribution pattern having a third cutoff line, and a fourth light source that emits a fifth light distribution pattern having a fourth cutoff line located above the third cutoff line, at least a portion of the fourth cutoff line being more blurred than the third cutoff line. The third light source is located at a focal point of the reflector, and the fourth light source is located behind the third light source.

The vehicle headlamp according to the above configuration includes the parabolic reflector, the third light source located at the focal point of the reflector, and the fourth light source located behind the third light source. By offsetting the fourth light source from the focal point of the reflector, the fourth cutoff line of the fifth light distribution pattern emitted from the fourth light source may be blurred. In the meantime, since the third light source is located at the focal point of the reflector, the third cutoff line is sharp. Therefore, according to the vehicle headlamp having the above configuration, it is possible to achieve both a light distribution pattern having a sharp cutoff line and a light distribution pattern having a blurred cutoff line with a simplified configuration.

According to the present disclosure, it is possible to provide a vehicle headlamp capable of forming a light distribution pattern with enhanced visibility at a low cost.

Further, according to the present disclosure, it is possible to provide a vehicle headlamp with a relatively simple configuration that is capable of implementing both a light distribution pattern having a sharp cutoff line and a light distribution pattern having a blurred cutoff line.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a vehicle equipped with a vehicle headlamp according to a first embodiment.

FIG. 2 is a block diagram illustrating a system configuration including the vehicle headlamp according to the first embodiment.

FIG. 3 is an exploded perspective view of the vehicle headlamp according to the first embodiment.

FIG. 4 is a diagram illustrating a low beam light distribution pattern during low beam lighting according to the first embodiment.

FIG. 5 is a diagram illustrating a high beam light distribution pattern during high beam lighting according to the first embodiment.

FIG. 6 is a perspective view of a vehicle equipped with a vehicle headlamp according to a second embodiment.

FIG. 7 is an exploded perspective view of the vehicle headlamp according to the second embodiment.

FIG. 8 is a diagram illustrating a low beam light distribution pattern during low beam lighting according to a modification of the first embodiment.

FIG. 9 is an exploded perspective view of a vehicle headlamp according to a third embodiment.

FIG. 10 is a side cross-sectional view of a first optical member according to a first example of the third embodiment.

FIG. 11 is a front cross-sectional view of the first optical member according to the first example of the third embodiment.

FIG. 12 is a diagram illustrating a low beam light distribution pattern during low beam lighting according to the first example of the third embodiment.

FIG. 13 is a diagram illustrating a high beam light distribution pattern during high beam lighting according to the first example of the third embodiment.

FIG. 14 is a side cross-sectional view of a first optical member according to a second example of the third embodiment.

FIG. 15 is a diagram illustrating a low beam light distribution pattern during low beam lighting according to the second example of the third embodiment.

FIG. 16 is an exploded perspective view of a vehicle headlamp according to a modification of the third embodiment.

FIG. 17 is a front cross-sectional view of a first optical member according to the modification of the third embodiment.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, the present embodiment will be described with reference to the drawings. The dimension of each member illustrated in the drawings may differ from the actual dimension of each member for the convenience of description.

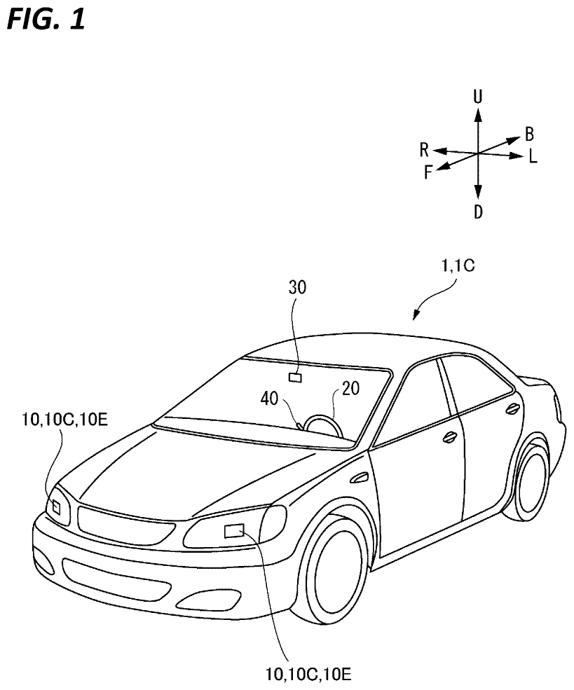

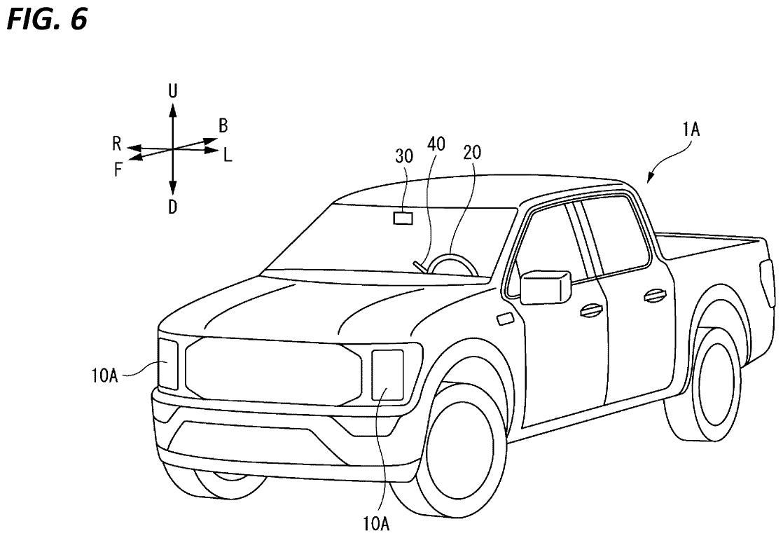

Further, in the description of the present embodiment, terms “left-right direction,” “up-down direction,” and “front-back direction” may be appropriately mentioned for the convenience of description. These directions are relative directions set with respect to a vehicle 1 or 1C illustrated in FIG. 1, or a vehicle 1A illustrated in FIG. 6. Here, the “left-right direction” refers to a direction that includes both the “leftward direction” and the “rightward direction”, and corresponds to the widthwise direction of the vehicle 1, 1C or 1A. The “up-down direction” refers to a direction that includes both the “upward direction” and the “downward direction.” The “front-back direction” refers to a direction that includes both the “forward direction” and the “backward direction.” The front-back direction is orthogonal to both the left-right direction and the up-down direction. In the drawings, the reference character “U” indicates the upward direction. The reference character “D” indicates the downward direction. The reference character “L” indicates the leftward direction. The reference character R indicates the rightward direction. The reference character “F” indicates the forward direction. The reference character “B” indicates the backward direction.

### First Embodiment

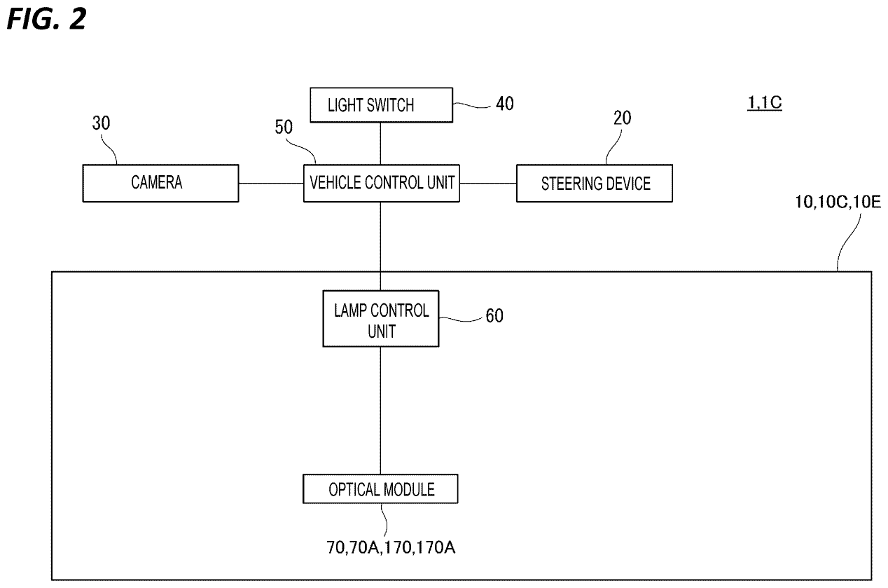

First, a vehicle headlamp 10 according to the present embodiment will be described below with reference to FIGS. 1 to 3. FIG. 1 is a perspective view of the vehicle 1 equipped with the vehicle headlamp 10. FIG. 2 is a block diagram illustrating a system configuration including the vehicle headlamp 10. The vehicle 1 is, for example, a vehicle (automobile) capable of traveling in a manual driving mode and/or an automatic driving mode.

As illustrated in FIGS. 1 and 2, the vehicle 1 includes the vehicle headlamp 10, a steering device 20, a camera 30, a light switch 40, and a vehicle control unit 50. As illustrated in FIG. 1, the vehicle headlamp 10 is arranged on each of the front right and front left sides of the vehicle 1. The steering device 20 is installed, for example, in the interior of the vehicle 1. The camera 30 is arranged, for example, near a windshield. The camera 30 is located between the vehicle headlamp 10 arranged on the front right side of the vehicle 1 and the vehicle headlamp 10 arranged on the front left side of the vehicle 1 in the widthwise direction (left-right direction in FIG. 1) of the vehicle 1. The light switch 40 is installed, for example, near the steering device 20.

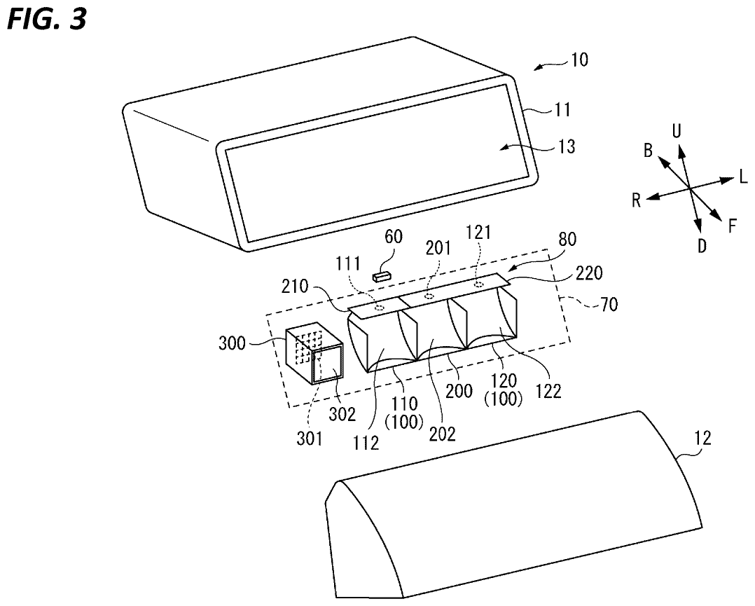

As illustrated in FIG. 2, the vehicle headlamp 10 includes a lamp control unit 60 and an optical module 70. Further, as illustrated in FIG. 3, the vehicle headlamp 10 includes a lamp body 11 having an opening at the front of the vehicle headlamp 10 and a light transmitting outer cover 12 that covers the opening of the lamp body 11. The lamp control unit 60 and the optical module 70 are accommodated inside a lamp chamber 13 formed by the lamp body 11 and the outer cover 12.

Referring back to FIG. 2, the steering device 20 will be described. The steering device 20 is configured, for example, with a steering wheel.

The camera 30 is, for example, a camera including an imaging device such as a charge-coupled device (CCD) or a complementary MOS (CMOS). The camera 30 acquires imaging data by capturing the images of surroundings of the vehicle 1 (e.g., a region in front of the vehicle 1). The camera 30 outputs the imaging data to the vehicle control unit 50.

The light switch 40 is configured, for example, to switch the vehicle headlamp 10 ON or OFF and to switch a light distribution pattern to be emitted, in response to the driver's operation of the vehicle 1. The driver of the vehicle 1 may select whether to activate a low beam or a high beam by operating the light switch 40. When the driver of the vehicle 1 operates the light switch 40, the light switch 40 generates a control signal for emitting a light distribution pattern in response to the operation, and transmits the signal to the vehicle control unit 50.

The vehicle control unit 50 is configured to control the traveling of the vehicle 1. The vehicle control unit 50 is configured to perform image analysis on the imaging data output from the camera 30. The vehicle control unit 50 detects surrounding environment information indicating the surrounding environment of the vehicle 1 from the imaging data, and transmits the surrounding environment information to the lamp control unit 60. The surrounding environment information includes, for example, position information on a target object (such as an oncoming vehicle or a preceding vehicle) located in front of the vehicle 1. The position information is, for example, an angular coordinate that indicates the azimuth of the target object as viewed from the vehicle 1 in terms of an angle. The vehicle control unit 50 is configured with, for example, at least one electronic control unit (ECU). The ECU includes, for example, a computer system including one or more processors and one or more memories as well as an electronic circuit including active elements such as transistors and passive elements.

The vehicle control unit 50 transmits a signal for controlling the vehicle headlamp 10 to the lamp control unit 60 based on the control signal from the light switch 40. For example, when the driver of the vehicle 1 operates the light switch 40 to emit a low beam light distribution pattern, the vehicle control unit 50 receives a control signal for emitting the low beam light distribution pattern from the light switch 40, and transmits the control signal to the lamp control unit 60. For example, when the driver of the vehicle 1 operates the light switch 40 to emit a high beam light distribution pattern, the vehicle control unit 50 receives a control signal for emitting the high beam light distribution pattern from the light switch 40, and transmits the control signal to the lamp control unit 60. The high beam light distribution pattern is, for example, an adaptive driving beam (ADB) light distribution pattern. The ADB light distribution pattern refers to a high beam light distribution pattern in which light is not emitted to a region where a target object such as a preceding vehicle or an oncoming vehicle is present and a non-emission region varies depending on the presence and position of the target object.

The lamp control unit 60 may have the same hardware configuration as the vehicle control unit 50. The lamp control unit 60 is configured to control the optical module 70 based on the surrounding environment information received from the vehicle control unit 50.

As illustrated in FIG. 3, the optical module 70 includes an optical unit 80 and a third optical member 300. The optical unit 80 includes a first optical member 100, a second optical member 200, a first substrate 210, and a second substrate 220. As illustrated in FIG. 3, the first optical member 100 and the second optical member 200 are configured as a single optical unit 80.

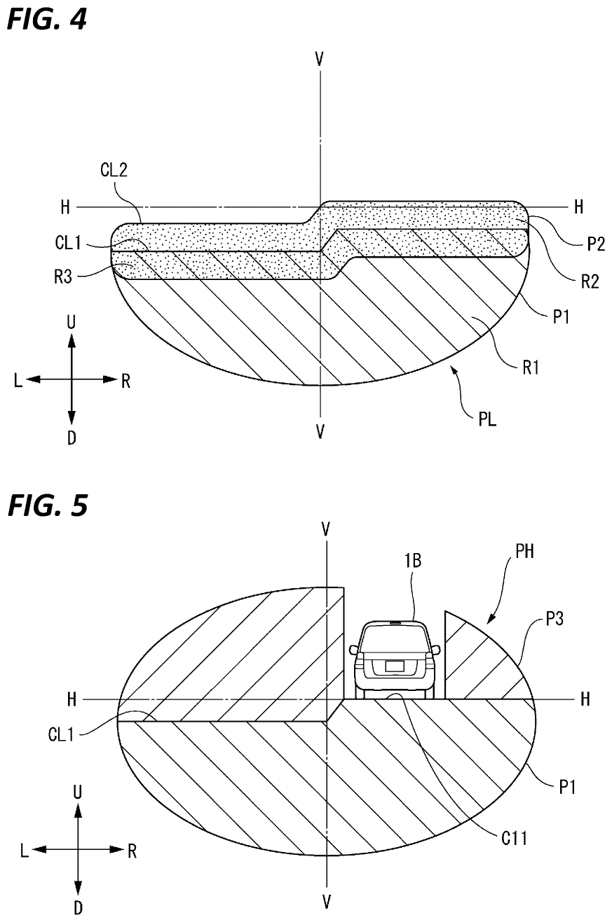

The first optical member 100 forms a first light distribution pattern P1 (see, e.g., FIG. 4) by irradiating at least a region below a first cutoff line CL1 with light. The first light distribution pattern P1 has the first cutoff line CL1 (see, e.g., FIG. 4). Details of the first light distribution pattern P1 will be described later. The first optical member 100 includes a first member 110 and a second member 120. In the present embodiment, the first member 110, the second optical member 200, and the second member 120 are arranged horizontally side by side in this order from right to left. However, the arrangement of the first member 110, the second member 120, and the second optical member 200 is not limited to this example.

The first member 110 includes a light source 111 (e.g., a first light source) and a reflector 112 (e.g., a first reflector). The light source 111 may be configured, for example, with a light emitting diode (LED) element or a laser diode (LD) element. The light source 111 is located above the reflector 112. The light source 111 is configured to emit light toward the reflector 112.

According to an embodiment, the reflector 112 is a parabolic reflector. The reflector 112 has a parabolic reflective surface. The reflector 112 may reflect light emitted from the light source 111 forward of the vehicle headlamp 10. The reflective surface of the reflector 112 is formed, for example, by a plurality of stepped surfaces. A light distribution pattern of any shape is formed by varying the direction of light reflected by each of the stepped surfaces.

The second member 120 includes a light source 121 (e.g., a first light source) and a reflector 122 (e.g., a first reflector). The light source 121 may have the same configuration as the light source 111. The reflector 122 may have the same configuration as the reflector 112. The light source 121 is located above the reflector 122. The light source 121 is configured to emit light toward the reflector 122. The reflector 122 reflects light emitted from the light source 121 forward of the vehicle headlamp 10. The reflective surface of the reflector 122 is formed, for example, by a plurality of stepped surfaces. A light distribution pattern of any shape is formed by varying the direction of light reflected by each of the stepped surfaces.

The second optical member 200 forms a second light distribution pattern P2 (see, e.g., FIG. 4) that is emitted to a position overlapping at least a portion of the first cutoff line CL1. The second light distribution pattern P2 has a second cutoff line CL2 (see, e.g., FIG. 4), which is more blurred than the first cutoff line CL1. Details of the second light distribution pattern P2 will be described later. The second optical member 200 includes a light source 201 (e.g., a second light source) and a reflector 202 (e.g., a second reflector). The light source 201 may have substantially the same configuration as the light source 111. The reflector 202 may have substantially the same configuration as the reflector 112. The light source 201 is located above the reflector 202. The light source 201 is configured to emit light toward the reflector 202. The reflector 202 reflects light emitted from the light source 201 forward of the vehicle headlamp 10. The reflective surface of the reflector 202 is formed, for example, by a plurality of stepped surfaces. A light distribution pattern of any shape is formed by varying the direction of light reflected by each of the stepped surfaces.

The first substrate 210 is, for example, a plate-shaped member made of an insulating material. The first substrate 210 includes a control circuit and others. The first substrate 210 is located above the first member 110. The light source 111 is mounted on the first substrate 210.

The second substrate 220 may have the same configuration as the first substrate 210. The second substrate 220 is located at the left of the first substrate 210. The second substrate 220 is located above the second member 120 and the second optical member 200. Both the light source 121 and the light source 201 are mounted on the first substrate 210.

The third optical element 300 is capable of irradiating a region, including at least a region above the first cutoff line CL1 or the second cutoff line CU, with light, and is capable of dimming any region within that region. The term “dimming” as used herein includes both blocking at least a part of light emitted from the third optical member 300 and reducing the intensity of the light emitted from the third optical member 300. The third optical element 300 forms, for example, a third light distribution pattern P3 (see, e.g., FIG. 5) to be described later.

The third optical member 300 includes a light source 301 and a projection lens 302. The light source 301 may be configured, for example, with a plurality of micro-LED light-emitting elements. The lighting states of the plurality of micro-LED light-emitting elements included in the light source 301 may be changed independently of each other. For example, in the vehicle headlamp 10, the lamp control unit 60 may perform ON/OFF control and brightness adjustment for each individual micro-LED light-emitting element included in the light source 301.

The projection lens 302 is, for example, a plano-convex lens having a convex front surface and a flat back surface. The projection lens 302 is made of a light transmitting material, for example, a transparent resin such as acryl. The projection lens 302 is configured to project light emitted from the light source 301 forward of the vehicle 1.

Next, a low beam light distribution pattern PL emitted from the vehicle headlamp 10 during low beam lighting and a high beam light distribution pattern PH emitted from the vehicle headlamp 10 during high beam lighting will be respectively described with reference to FIGS. 4 and 5.

The term “during low beam lighting” refers to a situation in which the driver of the vehicle 1 has operated the light switch 40 to emit the low beam light distribution pattern PL. The term “during high beam lighting” refers to a situation in which the driver of the vehicle 1 has operated the light switch 40 to emit the high beam light distribution pattern PH. Further, in FIGS. 4 and 5, hatching varies for each of regions with different brightness levels. For example, regions with the same hatching have the same brightness, and regions with different hatching patterns have different brightness levels.

In the present embodiment, a case where the vehicle 1 is traveling in the right lane will be described. The low beam light distribution pattern PL illustrated in FIG. 4 and the high beam light distribution pattern PH illustrated in FIG. 5 are projections on a virtual vertical screen at a predetermined position in front of the vehicle 1 (e.g., position 25 meters ahead of the vehicle 1). As for light distribution patterns illustrated in the subsequent drawings, each pattern represents a projection state onto a virtual vertical screen at a predetermined position in front of the vehicle 1. Further, FIGS. 4 and 5 also illustrate a V-V line indicating the vertical direction (e.g., up-down direction in FIGS. 4 and 5) at the irradiation range center of the vehicle headlamp 10 and an H-H line extending in the horizontal direction (e.g., left-right direction in FIGS. 4 and 5) orthogonal to the V-V line. The V-V line indicating the vertical direction at the irradiation range center of the vehicle headlamp 10 and the H-H line indicating the horizontal direction orthogonal to the V-V line are also illustrated in the subsequent drawings illustrating light distribution patterns.

First, the low beam light distribution pattern PL during low beam lighting in the present embodiment will be described with reference to FIG. 4. When the driver of the vehicle 1 operates the light switch 40 to emit the low beam light distribution pattern PL, the optical module 70 emits the low beam light distribution pattern PL. In this case, the low beam light distribution pattern PL illustrated in FIG. 4 is projected onto a virtual vertical screen at a predetermined position in front of the vehicle 1.

As illustrated in FIG. 4, in the present embodiment, the low beam light distribution pattern PL is formed by the first light distribution pattern P1 and the second light distribution pattern P2. For example, during low beam lighting, the first optical member 100 and the second optical member 200 are turned ON, while the third optical member 300 is turned OFF. The first light distribution pattern P1 has the first cutoff line CL1. The first light distribution pattern P1 is emitted by the first optical member 100 to a first region R1 (the region hatched with downward-right diagonal lines in FIG. 4) including the first cutoff line CL1 and a region below the first cutoff line CL1.

The second light distribution pattern P2 has the second cutoff line CL2. The second light distribution pattern P2 is emitted by the second optical member 200 to a second region R2 (e.g., the region hatched with dots in FIG. 4) including the second cutoff line CL2 and a region below the second cutoff line CL2. The second light distribution pattern P2 overlaps a part of the first light distribution pattern P1 (e.g., an upper portion of the first light distribution pattern P1). As used herein, a region where the upper portion of the first light distribution pattern P1 overlaps with the second light distribution pattern P2 is referred to as an overlapping region R3. The overlapping region R3 is hatched with a combination of downward-right diagonal lines and dots.

The brightness of the overlapping region R3 differs from that of the first region R1 and the second region R2. In the present embodiment, the overlapping region R3 is brighter than both the first region R1 and the second region R2. The first region R1 and the second region R2 are brighter than a region where no light is emitted (e.g., a region below the first region R1, or a region above the second cutoff line CL2). The first region R1 is, for example, darker than the second region R2. However, the first region R1 may also be brighter than the second region R2, or may have approximately the same brightness as the second region R2. Accordingly, in the present embodiment, the brightness order is: the overlapping region R3 is the brightest, followed by the second region R2, then the first region R1, and finally the region where no light is emitted.

As illustrated in FIG. 4, in the low beam light distribution pattern PL, the first region R1, the overlapping region R3, the second region R2, and the region where no light is emitted are arranged from bottom to top, with the brightness changing in four levels. Further, as described above, since the second region R2 is darker than the overlapping region R3, the brightness gradually decreases, in particular, from the overlapping region R3 to the second region R2 and further to the region where no light is emitted. For example, the cutoff line of the low beam light distribution pattern PL exhibits a change in brightness in two levels (or three levels when the region where no light is emitted is also counted).

Next, the high beam light distribution pattern PH during high beam lighting in the present embodiment will be described with reference to FIG. 5. When the driver of the vehicle 1 operates the light switch 40 to emit the high beam light distribution pattern PH, the optical module 70 emits the high beam light distribution pattern PH. In this case, the high beam light distribution pattern PH illustrated in FIG. 5 is projected onto a virtual vertical screen at a predetermined position in front of the vehicle 1. the high beam light distribution pattern PH illustrated in FIG. 5 is an ADB light distribution pattern.

As illustrated in FIG. 5, in the present embodiment, the high beam light distribution pattern PL is formed by the first light distribution pattern P1 and the third light distribution pattern P3. For example, during high beam lighting, the first optical member 100 and the third optical member 300 are turned ON, and the second optical member 200 is turned OFF. The first light distribution pattern P1 is formed in a region below the cutoff line CL1, and the third light distribution pattern P3 is formed in a region above the cutoff line CL1. In FIG. 5, the region where the first light distribution pattern P1 is formed is hatched with downward-right diagonal lines, and the region where the third light distribution pattern P3 is formed is hatched with upward-right diagonal lines.

In the example illustrated in FIG. 5, since there is a preceding vehicle 1B in front of the vehicle 1, the camera 30 outputs imaging data related to the preceding vehicle 1B to the vehicle control unit 50. The vehicle control unit 50 detects surrounding environment information, including position information on the preceding vehicle 1B, from the imaging data output from the camera 30, and transmits the surrounding environment information to the lamp control unit 60. The lamp control unit 60 controls the second optical member 200 included in the optical module 70, so as not to emit light toward the preceding vehicle 1B, based on the surrounding environment information received from the vehicle control unit 50. Therefore, the surrounding region of the preceding vehicle 1B is shaded in the example illustrated in FIG. 5.

In this way, since the surrounding region of the preceding vehicle 1B is shaded and the second light distribution pattern P2 is not emitted during high beam lighting, a portion C11 of the first cutoff line Cl1, located below the preceding vehicle 1B, exhibits a clear contrast between light and dark. For example, the first cutoff line CL1 is formed by a region where the third light distribution pattern P3 is emitted and a region where the third light distribution pattern P3 is not emitted, and the brightness does not change in two levels near the first cutoff line CL1. When including the region where no light is emitted, the cutoff line of the high beam light distribution pattern PH changes in only two brightness levels. Therefore, the second cutoff line CL2, formed when the low beam light distribution pattern PL is emitted, appears more blurred than at least a portion of the first cutoff line CL1 (in the present embodiment, the portion C11 of the first cutoff line CL1 located below the preceding vehicle 1B) formed when the high beam light distribution pattern PH (ADB light distribution pattern) is emitted.

In a typical low beam light distribution pattern, the contrast at the cutoff line is clearly defined. The cutoff line in the typical low beam light distribution pattern does not change in brightness in two levels. Therefore, the second cutoff line CL2 of the low beam light distribution pattern PL appears more blurred than the cutoff line of the typical low beam light distribution pattern.

There is a demand for forming a low beam light distribution pattern that is easy to see by blurring the cutoff line, while there is also a demand for simplifying the configuration of a vehicle headlamp as much as possible to reduce manufacturing costs. For example, there is a demand for a vehicle headlamp that provides both high product appeal and affordability.

According to the vehicle headlamp 10 having the above configuration, the second optical member 200 forms the second light distribution pattern P2, which has a second cutoff line CL2 more blurred than the first cutoff line CL1 and is emitted to a position overlapping a portion of the first cutoff line CL1. The second optical member 200 includes the light source 201 and the parabolic reflector 202 that reflects light emitted from the light source 201 forward of the vehicle headlamp 10. According to an embodiment, the second optical member 200 is a parabolic optical member that is inexpensive and is more likely to form a light distribution pattern having a blurred cutoff line, compared to the cutoff line of a light distribution pattern formed by, for example, a PES-type optical member. The vehicle headlamp 10 includes the second optical member 200, and therefore, may form a light distribution pattern with enhanced visibility at a low cost.

In the present embodiment, the vehicle headlamp is assumed to be mounted on a vehicle traveling in a region where the right lane is defined as the traveling lane and the left lane as the passing lane. In such a region, a preceding vehicle appears on the right side of the V-V line, and an oncoming vehicle appears on the left side of the V-V line. In the present embodiment, the second light distribution pattern P2 is emitted to the first cutoff line at the right side of the V-V line. For example, a portion of the first cutoff line at the right side of the V-V line is more blurred than a portion at the left side. The eye level of the driver of the oncoming vehicle is near the horizon, while the eye level of the driver of the preceding vehicle (e.g., the height of the rearview mirror) is higher than the horizon. Therefore, the line of sight of the oncoming vehicle's driver is close in the height direction to the first cutoff line, while the line of sight of the preceding vehicle's driver is separated in the height direction from the first cutoff line. Therefore, it is unlikely to cause glare to the preceding vehicle even if a portion of the first cutoff line at the right side of the V-V line is irradiated in a blurred manner with the second light distribution pattern P2. Further, blurring a portion of the cutoff line in this way may enhance the driver's visibility of the host vehicle.

Further, according to the vehicle headlamp 10 having the above configuration, since both the first optical member 100 and the second optical member 200 are parabolic optical members, a sense of unity is achieved, resulting in an aesthetically pleasing design.

Further, according to the vehicle headlamp 10 having the above configuration, it is possible to reduce the number of components of the vehicle headlamp 10 since the first optical member 100 and the second optical member 200 are configured as a single optical unit 80.

Further, according to the vehicle headlamp 10 having the above configuration, the first optical member 100 and the third optical member 300 are turned ON during high beam lighting, while the first optical member 100 and the second optical member 200 are turned ON during low beam lighting. For example, the second optical unit 200 is turned ON during low beam lighting, but is turned OFF during high beam lighting. In this way, since the ON/OFF state of the second optical member 200 is independent from the ON/OFF state of the first optical member 100, the vehicle headlamp 10 may form an appropriate light distribution pattern depending on the situation.

### Second Embodiment

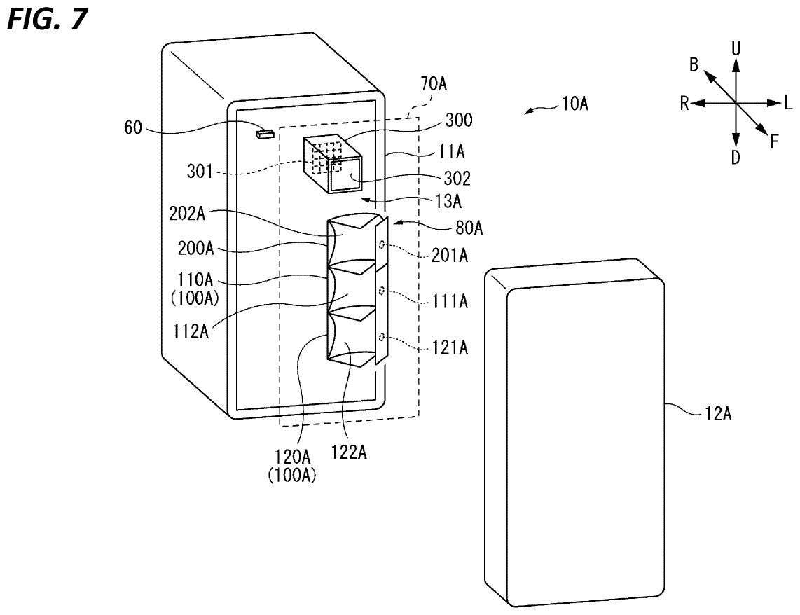

Next, a vehicle headlamp 10A according to a second embodiment will be described with reference to FIGS. 6 and 7. In the present embodiment, the same parts as those in the first embodiment are described using the same reference numerals, and descriptions of duplicate parts are omitted as appropriate. A vehicle 1A according to the present embodiment differs from the vehicle 1 according to the first embodiment in that it includes the vehicle headlamp 10A instead of the vehicle headlamp 10. As illustrated in FIG. 6, the vehicle 1A is, for example, a pickup truck. In the present embodiment, it is assumed that the vehicle 1A is traveling in the right lane.

As illustrated in FIG. 7, the vehicle headlamp 10A includes the lamp control unit 60 and an optical module 70A. The vehicle headlamp 10A includes a lamp body 11A having an opening at the front of the vehicle headlamp 10A and a light transmitting outer cover 12A that covers the opening of the lamp body 11A. The lamp control unit 60 and the optical module 70A are accommodated inside a lamp chamber 13A formed by the lamp body 11A and the outer cover 12A. The optical module 70A includes an optical unit 80A and the third optical member 300.

The optical unit 80A includes a first optical member 100A and a second optical member 200A. For example, the first optical member 100A and the second optical member 200A are configured as a single optical unit 80A. The first optical element 100A forms the first light distribution pattern P1 (see, e.g., FIG. 4). The first optical member 100A includes a first member 110A and a second member 120A.

The first member 110A, the second member 120A, and the second optical member 200A are arranged in the order of the second optical member 200A at the top, followed by the first member 110A, and then the second member 120A in the height direction (e.g., up-down direction in FIGS. 6 and 7) of the vehicle 1A on which the vehicle headlamp 10A is mounted. Accordingly, the second optical member 200A is located above the first optical member 100A.

The first member 110A includes a light source 111A (an example of a first light source) and a reflector 112A (e.g., a first reflector). The light source 111A may have the same configuration as the light source 111. The light source 111A is located at the left side of the reflector 112A.

Although the reflector 112A has approximately the same configuration as the reflector 112, the stepped surfaces of the reflector 112A differ from those of the reflector 112 since the light source 111A is located at the left side of the reflector 112A. In the present embodiment, the stepped surfaces of the reflector 112A reflect light emitted from the light source 111A forward of the vehicle headlamp 10A.

The second member 120A includes a light source 121A (e.g., a first light source) and a reflector 122A (e.g., a first reflector). The light source 121A may have the same configuration as the light source 111. The reflector 122A may have the same configuration as the reflector 112A. The light source 121A is located at the left side of the reflector 122A. The light source 121A is configured to emit light toward the reflector 122A. The reflector 122A may reflect light emitted from the light source 121A by the stepped surfaces of the reflector 122A, thereby reflecting the light forward of the vehicle headlamp 10A.

In this way, the first optical member 100A includes a plurality of reflectors (e.g., reflectors 112A and 122A). Further, the reflectors 112A and 122A are arranged in the height direction (e.g., up-down direction in FIG. 7) of the vehicle 1A on which the vehicle headlamp 10A is mounted. Furthermore, the reflectors 112A and 122A are arranged in a linear configuration.

The second optical element 200A forms the second light distribution pattern P2 (see, e.g., FIG. 4). The second optical member 200A includes a light source 201A (e.g., a second light source) and a reflector 202A (e.g., a second reflector). The light source 201A may have the same configuration as the light source 111. The reflector 202A may have the same configuration as the reflector 112A. The light source 201A is located at the left side of the reflector 202A. The light source 201A is configured to emit light toward the reflector 202A. The reflector 202A may reflect light emitted from the light source 201A by the stepped surfaces of the reflector 202A, thereby reflecting the light forward of the vehicle headlamp 10A.

Since the second optical member 200A is located above the first optical member 100A, in the vehicle headlamp 10A, it is easier to emit the second light distribution pattern P2 above the first light distribution pattern P1.

In the present embodiment as well, the lamp control unit 60 controls the optical module 70A having the optical unit 80A according to the same principle as in the first embodiment. Accordingly, in the present embodiment as well, the low beam light distribution pattern PL is emitted from the vehicle headlamp 10A during low beam lighting, and the high beam light distribution pattern PH is emitted from the vehicle headlamp 10A during high beam lighting. In the present embodiment as well, the high beam light distribution pattern PH is an ADB distribution pattern.

For example, when the driver of the vehicle 1A operates the light switch 40 to emit the low beam light distribution pattern PL, the vehicle headlamp 10A projects the low beam light distribution pattern PL as illustrated in FIG. 4 onto a virtual vertical screen at a predetermined position in front of the vehicle 1A.

For example, when the driver of the vehicle 1A operates the light switch 40 to emit the high beam light distribution pattern PH, and another vehicle (e.g., the preceding vehicle 1B illustrated in FIG. 5) is present in at least a part of the irradiation region of the second light distribution pattern P2, the second optical member 200A is controlled such that light is not emitted from the light source 201A. Accordingly, in this case, the vehicle headlamp 10A projects the high beam light distribution pattern PH as illustrated in FIG. 5 onto a virtual vertical screen at a predetermined position in front of the vehicle 1A.

The vehicle headlamp 10A according to the present embodiment also exhibits the same effects as the vehicle headlamp 10 according to the first embodiment.

Further, according to the vehicle headlamp 10A having the above configuration, the vehicle headlamp 10A includes the second optical member 200A, which is a parabolic optical member that is inexpensive and is more likely to form a light distribution pattern having a blurred cutoff line compared to the cutoff line of a light distribution pattern formed by a PES-type optical member. Accordingly, the vehicle headlamp 10A may form a light distribution pattern with enhanced visibility at a low cost. Further, the first optical member 100A and the second optical member 200A are arranged in the height direction of the vehicle 1A on which the vehicle headlamp 10A is mounted, and the second optical member 200A is located above the first optical member 100A. Therefore, when the vehicle headlamp 10A is mounted on the vehicle 1A with a relatively high attachment position of the vehicle headlamp 10A, such as a pickup truck, the vehicle headlamp 10A may form a light distribution pattern with enhanced visibility by emitting light in a linear path from the second optical member 200A, and also has an aesthetically pleasing design.

Further, according to the vehicle headlamp 10A having the above configuration, the plurality of reflectors (e.g., reflectors 112A and 122A) included in the first optical member 100A are arranged in the height direction of the vehicle 1A on which the vehicle headlamp 10A is mounted. Therefore, the vehicle headlamp 10A has an aesthetically pleasing design when mounted on the vehicle 1A with a relatively high attachment position of the vehicle headlamp 10A, such as a pickup truck.

Further, according to the vehicle headlamp 10A having the above configuration, the plurality of reflectors (e.g., reflectors 112A and 122A) of the first optical member 100A are arranged in a linear configuration. Therefore, the vehicle headlamp 10A has an aesthetically pleasing design when mounted on the vehicle 1A with a relatively high attachment position of the vehicle headlamp 10A, such as a pickup truck.

Further, according to the vehicle headlamp 10A having the above configuration, since light is not emitted from the light source 201A of the second optical member 200A when the preceding vehicle 1B is present in at least a part of the irradiation region of the second light distribution pattern P2, it is possible to prevent glare to the preceding vehicle 1B.

### Modification of First Embodiment

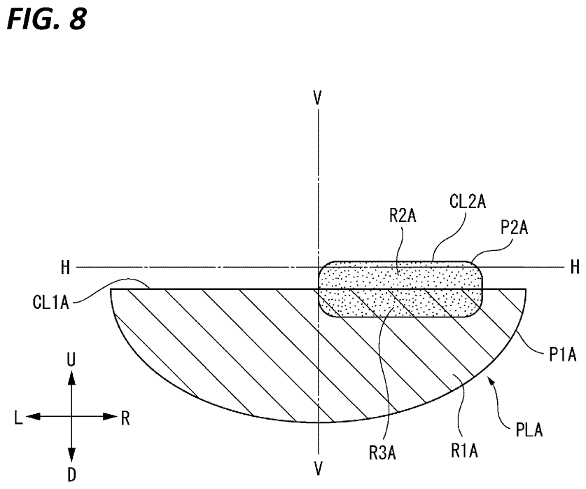

Next, a low beam light distribution pattern PLA during low beam lighting in a modification of the first embodiment will be described with reference to FIG. 8. In this modification, the first optical member 100 forms a first light distribution pattern P1A having a first cutoff line CL1A by irradiating at least a region below the first cutoff line CL1A with light. The second optical member 200 forms a second light distribution pattern P2A that has a second cutoff line CL2A more blurred than the first cutoff line CL1 and is emitted to a position overlapping a portion of the first cutoff line CL1A.

When the driver of the vehicle 1 operates the light switch 40 to emit the low beam light distribution pattern PLA, the vehicle headlamp 10 projects the low beam light distribution pattern PLA as illustrated in FIG. 8 onto a virtual vertical screen at a predetermined position in front of the vehicle 1. Further, in FIG. 8, hatching varies for each of regions with different brightness levels. For example, regions with the same hatching have the same brightness, and regions with different hatching patterns have different brightness levels. The high beam light distribution pattern projected onto the virtual vertical screen at a predetermined position in front of the vehicle 1 when the driver of the vehicle 1 operates the light switch 40 to emit the high beam light distribution pattern PH corresponds to the high beam light distribution pattern PH in the first embodiment.

As illustrated in FIG. 8, in this modification, the low beam light distribution pattern PLA is formed by the first light distribution pattern P1A and the second light distribution pattern P2A. For example, during low beam lighting, the first optical member 100 and the second optical member 200 are turned ON, and the third optical member 300 is turned OFF. The first light distribution pattern P1A is emitted by the first optical member 100 to a first region R1A (the region hatched with downward-right diagonal lines in FIG. 8) including the first cutoff line CL1A and a region below the first cutoff line CL1A.

The second light distribution pattern P2A is emitted by the second optical member 200 to a second region R2A (e.g., the region hatched with dots in FIG. 8) including the second cutoff line CL2A and a region below the second cutoff line CL2A. The second light distribution pattern P2A overlaps with a part of the first light distribution pattern P1A (e.g., an upper portion of the first light distribution pattern P1A). As used herein, a region where the upper portion of the first light distribution pattern P1A overlaps with the second light distribution pattern P2A is referred to as an overlapping region R3A. The overlapping region R3A is hatched with a combination of downward-right diagonal lines and dots.

The brightness of the overlapping region R3A differs from that of the first region R1A and the second region R2A. In this modification, the overlapping region R3A is brighter than both the first region R1A and the second region R2A. The first region R1A and the second region R2A are brighter than a region where no light is emitted (e.g., a region below the first region R1A or a region above the second cutoff line CL2A). The first region R1A is, for example, darker than the second region R2A. However, the first region R1A may also be brighter than the second region R2A, or may have approximately the same brightness as the second region R2A. Accordingly, in this modification, the brightness order is: the overlapping region R3A is the brightest, followed by the second region R2A, then the first region R1A, and finally the region where no light is emitted.

As illustrated in FIG. 8, in the low beam light distribution pattern PLA, the first region R1A, the overlapping region R3A, the second region R2A, and the region where no light is emitted are arranged from bottom to top, with the brightness changing in four levels. Further, as described above, since the second region R2A is darker than the overlapping region R3A, the brightness gradually decreases, in particular, from the overlapping region R3A to the second region R2A and further to the region where no light is emitted. For example, the cutoff line of the low beam light distribution pattern PLA exhibits a change in brightness in two levels (or three levels if the region where no light is emitted is also counted).

In this modification as well, the same effects as those in the first embodiment are achieved.

### Third Embodiment

Next, a third embodiment will be described with reference to FIGS. 1, 2, and 9 to 17. In the present embodiment, the same parts as those in the first embodiment, the modification of the first embodiment, the second embodiment are described using the same reference numerals, and descriptions of duplicate parts are omitted as appropriate. As illustrated in FIG. 1, the vehicle 1C according to the present embodiment differs from the vehicle 1 of the first embodiment in that it includes a vehicle headlamp 10C instead of the vehicle headlamp 10, but is basically the same as the vehicle 1 according to the first embodiment in other respects. Further, as illustrated in FIG. 2, the vehicle headlamp 10C according to the present embodiment includes the lamp control unit 60 and an optical module 170.

### First Example of Third Embodiment

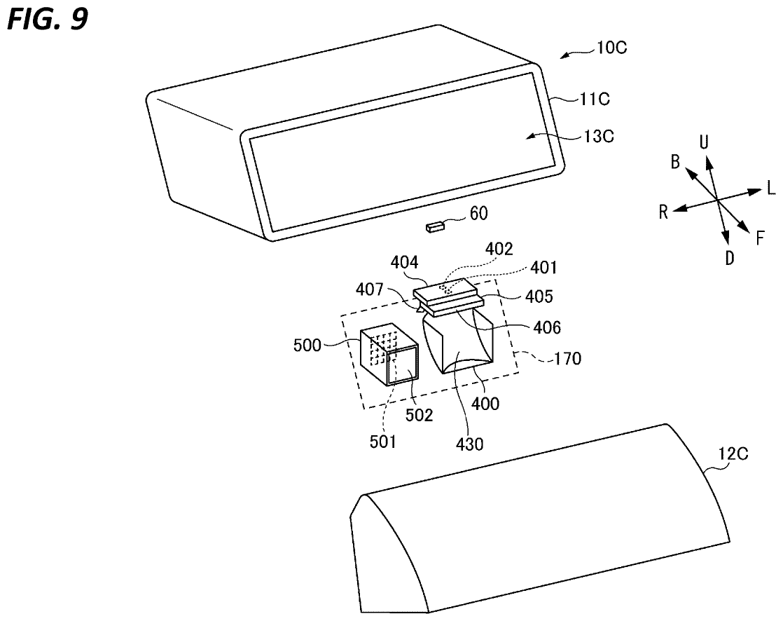

As illustrated in FIG. 9, the vehicle headlamp 10C includes a lamp body 11C having an opening at the front of the vehicle headlamp 10C and a light transmitting outer cover 12C that covers the opening of the lamp body 11C. The lamp control unit 60 and the optical module 170 are accommodated inside a lamp chamber 13C formed by the lamp body 11C and the outer cover 12C.

The optical module 170 includes a fourth optical member 400 and a fifth optical member 500. The fourth optical member 400 is located at the left side of the fifth optical member 500. However, the fourth optical member 400 may be located, for example, at the right side of the fifth optical member 500.

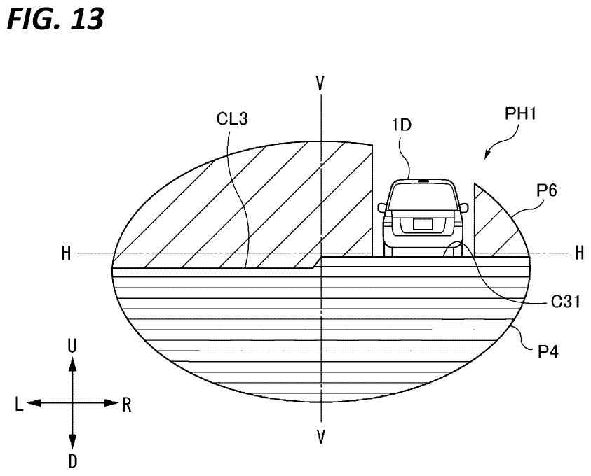

The fifth optical member 500 includes a light source 501 (an example of a fifth light source) and a projection lens 502. The light source 501 may be configured, for example, with a plurality of micro-LED light-emitting elements. The lighting states of the plurality of micro-LED light-emitting elements included in the light source 501 may be changed independently from each other. For example, in the vehicle headlamp 10C, the lamp control unit 60 may perform ON/OFF control and brightness adjustment for each individual micro-LED light-emitting element included in the light source 501. The light source 501 is capable of emitting light to a region including a region above the third cutoff line CL3, and is capable of dimming any region within that region. the term “dimming” as used herein includes both blocking at least a part of light emitted from the light source 501 and reducing the intensity of the light emitted from the light source 501. The light source 501 emits, for example, a sixth light distribution pattern P6 (see, e.g., FIG. 13) to be described later.

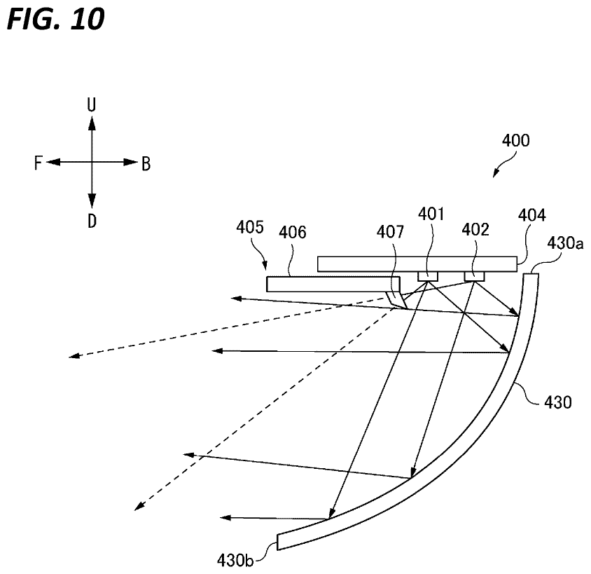

FIG. 10 is a side cross-sectional view of the fourth optical member 400 according to the present embodiment. As illustrated in FIG. 10, the fourth optical member 400 includes a light source 401 (e.g., a third light source), a light source 402 (e.g., a fourth light source), a reflector 430, and a shade 405. The light sources 401 and 402 are installed on a substrate 404.

The light source 401 may be configured with, for example, an LED element or an LD element. The light source 401 is located at the focal point of the reflector 430. The light source 401 is configured to emit light toward the reflector 430. The light source 401 emits light toward the reflector 430 to emit a fourth light distribution pattern P4 (see, e.g., FIG. 12) having a third cutoff line CL3 (see, e.g., FIG. 12). Details of the fourth light distribution pattern P4 will be described later.

The light source 402 may have the same configuration as the light source 401. The light source 402 is configured to emit light toward the reflector 430. The light source 402 emits light toward the reflector 430, thereby emitting a fifth light distribution pattern P5 (see, e.g., FIG. 12) having a fourth cutoff line CL4 (see, e.g., FIG. 12) located above the third cutoff line CL3, at least a part of the fourth cutoff line being more blurred than the third cutoff line CL3. Details of the fifth light distribution pattern P5 will be described later.

The light source 402 is located behind the light source 401. For example, the light source 402 is installed at a position offset backward from the focal point of the reflector 430.

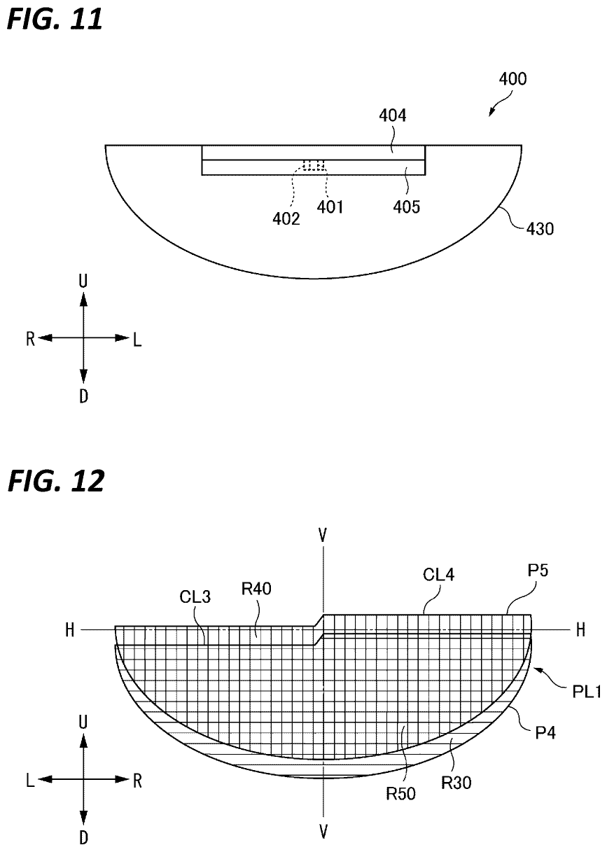

FIG. 11 is a front cross-sectional view of the first optical member according to the present embodiment. As illustrated in FIG. 11, the light sources 401 and 402 are arranged to overlap each other in a front view. For the convenience of description, the light source 402 is depicted larger than the light source 401 in FIG. 11, but the light sources 401 and 402 may be of approximately the same size.

The light sources 401 and 402 may be individually controlled by the lamp control unit 60. For example, the ON/OFF states of the light sources 401 and 402 are independent from each other, and are not interdependent. Therefore, for example, when the light source 401 is in an ON state, the light source 402 may be either in an ON state or in an OFF state.

As illustrated in FIG. 10, the reflector 430 is a parabolic reflector. The reflector 430 is curved in a side cross-sectional view. In the side cross-sectional view, an upper end 430a of the reflector 430 is located behind the light sources 401 and 402, and a lower end 430b of the reflector 430 is located in front of the light sources 401 and 402. In the present embodiment, light emitted from the light sources 401 and 402 is reflected by the common reflector 430. For example, at least the light sources 401 and 402 and the reflector 430 constitute a single fourth optical member 400.

The reflector 430 has, for example, a parabolic reflective surface. The reflector 430 is capable of reflecting light emitted from the light source 401 and/or the light source 402 forward of the vehicle headlamp 10C. The reflective surface of the reflector 430 is formed, for example, by a plurality of stepped surfaces. For example, a light distribution pattern of any shape is formed by varying the direction of light reflected by each of the stepped surfaces.

The substrate 404 is, for example, a plate-shaped member made of an insulating material. The substrate 404 includes a control circuit and others. Both the light source 401 and the light source 402 are mounted on the substrate 404. The substrate 404 is located above the light sources 401 and 402, the reflector 430, and the shade 405.

The shade 405 is made of, for example, a resin material. The shade 405 is located in front of the light sources 401 and 402. The shade 405 includes a plate-shaped portion 406 and a protrusion 407 extending downward from the rear end of the plate-shaped portion 406. As illustrated by the broken lines in FIG. 10, the protrusion 407 blocks a part of light emitted from the light sources 401 and 402. In the present embodiment, the protrusion 407 blocks light that is emitted obliquely downward and forward from the light sources 401 and 402 and does not enter the reflector 430. For example, the protrusion 407 blocks light that is emitted from the light sources 401 and 402 but is not directed toward the reflector 430. Therefore, the shade 405 may block light from the light sources 401 and 402 that would otherwise be directed toward the ground. Further, the shade 405 may prevent stray light caused by light entering other components of the vehicle headlamp 10C.

Next, a low beam light distribution pattern PL1 emitted from the vehicle headlamp 10C during low beam lighting and a high beam light distribution pattern PH1 emitted from the vehicle headlamp 10C during high beam lighting will be respectively described with reference to FIGS. 12 and 13.

The term “during low beam lighting” refers to a situation in which the driver of the vehicle 1C has operated the light switch 40 to emit the low beam light distribution pattern PL1. The term “high beam lighting” refers to a situation in which the driver of the vehicle 1C has operated the light switch 40 to emit the high beam light distribution pattern PH1.

In the present embodiment, a case where the vehicle 1C is traveling in the right lane will be described. The low beam light distribution pattern PL1 illustrated in FIG. 12 and the high beam light distribution pattern PH1 illustrated in FIG. 13 are projection states on a virtual vertical screen at a predetermined position in front of the vehicle 1C (e.g., a position which is 25 meters ahead of the vehicle 1). As for light distribution patterns illustrated in the subsequent drawings, each pattern represents a projection state onto a virtual vertical screen at a predetermined position in front of the vehicle 1C. Further, FIGS. 12 and 13 also illustrate a V-V line indicating the vertical direction (e.g., up-down direction in FIGS. 12 and 13) at the irradiation range center of the vehicle headlamp 10C and an H-H line extending in the horizontal direction (e.g., left-right direction in FIGS. 12 and 13) orthogonal to the V-V line. The V-V line indicating the vertical direction at the irradiation range center of the vehicle headlamp 10C and the H-H line indicating the horizontal direction orthogonal to the V-V line are also illustrated in the subsequent drawings illustrating light distribution patterns.

First, the low beam light distribution pattern PL during low beam lighting in the present embodiment will be described with reference to FIG. 12. When the driver of the vehicle 1C operates the light switch 40 to emit the low beam light distribution pattern PL1, the optical module 170 emits the low beam light distribution pattern PL1. In this case, the low beam light distribution pattern PL1 illustrated in FIG. 12 is projected onto a virtual vertical screen at a predetermined position in front of the vehicle 1C.

As illustrated in FIG. 12, in the present embodiment, the low beam light distribution pattern PL1 is formed by the fourth light distribution pattern P4 and the fifth light distribution pattern P5. For example, the light sources 401 and 402 are turned ON and the light source 501 is turned OFF during low beam lighting. The fourth light distribution pattern P4 has the third cutoff line CL3. The fourth light distribution pattern P4 is emitted by the light source 401 to a third region R30 (e.g., the region hatched with horizontal lines in FIG. 12) including the third cutoff line CL3 and a region below the third cutoff line CL3.

The fifth light distribution pattern P5 has the fourth cutoff line CL4. The fifth light distribution pattern P5 is emitted by the light source 402 to a fourth region R40 (e.g., the region hatched with vertical lines in FIG. 12) including the fourth cutoff line CL4 and a region below the fourth cutoff line CL4. The fifth light distribution pattern P5 is emitted to a position slightly above the fourth light distribution pattern P4. Further, a lower portion of the fifth light distribution pattern P5 overlaps with an upper portion of the fourth light distribution pattern P4. As used herein, a region where the upper portion of the fourth light distribution pattern P4 overlaps with the lower portion of the fifth light distribution pattern P5 is referred to as an overlapping region R50. The overlapping region R50 is hatched with a combination of horizontal and vertical lines.

The brightness of the overlapping region R50 differs from that of the third region R30 and the fourth region R40. In the present embodiment, the overlapping region R50 is brighter than both the third region R30 and the fourth region R40. The third region R30 and the fourth region R40 are brighter than a region where no light is emitted (e.g., a region below the third region R30 or a region above the fourth cutoff line CL4). The third region R30 has, for example, approximately the same brightness as the fourth region R40.

The light source 401 is located at the focal point of the reflector 430, whereas the light source 402 is located at a position offset backward from the focal point of the reflector 430. Therefore, the fourth light distribution pattern P4 appears sharp, whereas the fifth light distribution pattern P5 appears blurred overall. Further, since the brightness in the overlapping region R50 is uniform, it does not appear blurred. Furthermore, since the fourth region R40 is darker than the overlapping region R50, in the low beam light distribution pattern PL1, the brightness gradually decreases from the overlapping region R50 to the fourth region R40 and further to the region where no light is emitted. For example, the cutoff line of the low beam light distribution pattern PL1 exhibits a change in brightness in two levels (or three levels when the region where no light is emitted is also counted). Therefore, the third cutoff line CL3 appears sharp, whereas the fourth cutoff line CL4 is more blurred than the third cutoff line CL3.

Next, the high beam light distribution pattern PH1 during high beam lighting in the present embodiment will be described with reference to FIG. 13. When the driver of the vehicle 1C operates the light switch 40 to emit the high beam light distribution pattern PH1, the optical module 170 emits the high beam light distribution pattern PH1. In this case, the high beam light distribution pattern PH1 illustrated in FIG. 13 is projected onto a virtual vertical screen at a predetermined position in front of the vehicle 1C. The high beam light distribution pattern PH1 illustrated in FIG. 13 is an ADB light distribution pattern.

As illustrated in FIG. 13, in the present embodiment, the high beam light distribution pattern PH1 is formed by the fourth light distribution pattern P4 and the sixth light distribution pattern P6. For example, the light sources 401 and 501 are turned ON, and the light source 402 is turned OFF during high beam lighting. The fourth light distribution pattern P4 is formed in a region below the third cutoff line CL3, and the sixth light distribution pattern P6 is formed in a region above the third cutoff line CL3. In FIG. 13, the region where the fourth light distribution pattern P4 is formed is hatched with horizontal lines, and the region where the sixth light distribution pattern P6 is formed is hatched with upward-right diagonal lines.

In the example illustrated in FIG. 13, since there is a preceding vehicle 1D in front of the vehicle 1C, the camera 30 outputs imaging data related to the preceding vehicle 1D to the vehicle control unit 50. The vehicle control unit 50 detects surrounding environment information, including position information on the preceding vehicle 1D, from the imaging data output from the camera 30, and transmits the surrounding environment information to the lamp control unit 60. The lamp control unit 60 controls the fifth optical member 500 included in the optical module 170, so as not to emit light toward the preceding vehicle 1D, based on the surrounding environment information received from the vehicle control unit 50. Therefore, the surrounding region of the preceding vehicle 1D is shaded in the example illustrated in FIG. 13.

In this way, since the surrounding region of the preceding vehicle 1D is shaded and the fifth light distribution pattern P5 is not emitted during high beam lighting, a portion C31 of the third cutoff line CL3, located below the preceding vehicle 1D, exhibits a clear contrast between light and dark. For example, the third cutoff line CL3 is formed by a region where the sixth light distribution pattern P6 is emitted and a region where the sixth light distribution pattern P6 is not emitted, and the brightness does not change in two levels near the third cutoff line CL3. When including the region where no light is emitted, the cutoff line of the high beam light distribution pattern PH1 changes in brightness in only two levels. Therefore, the fourth cutoff line CL4, formed when the low beam light distribution pattern PL1 is emitted, appears more blurred than at least a portion of the third cutoff line CL3 (e.g., in the present embodiment, the portion C31 of the third cutoff line CL3 located below the preceding vehicle 1D) formed when the high beam light distribution pattern PH1 (ADB light distribution pattern) is emitted.

In a typical low beam light distribution pattern, the contrast at the cutoff line is clearly defined. The cutoff line in the typical low beam light distribution pattern does not change in brightness in two levels. Therefore, the fourth cutoff line CL4 of the low beam light distribution pattern PL1 appears more blurred than the cutoff line of the typical low beam light distribution pattern.

Incidentally, a light distribution pattern with a sharp cutoff line is required, in order to avoid causing glare to oncoming or preceding vehicles. In the meantime, there are cases where a light distribution pattern with a blurred cutoff line is required to enhance the driver's long-distance visibility.

According to the vehicle headlamp 10C having the above configuration, the parabolic reflector 430, the light source 401 located at the focal point of the reflector 430, and the light source 402 located behind the light source 401 are provided. By offsetting the light source 402 from the focal point of the reflector 430, the fourth cutoff line CL4 of the fifth light distribution pattern P5 emitted from the light source 403 may be blurred. Meanwhile, the third cutoff line CL3 appears sharp since the light source 401 is located at the focal point of the reflector 430. Therefore, according to the vehicle headlamp 10C, it is possible to achieve both a light distribution pattern having a sharp cutoff line and a light distribution pattern having a blurred cutoff line with a simple configuration.

Further, according to the vehicle headlamp 10C having the above configuration, since the ON/OFF states of the light sources 401 and 402 are individually controlled, an appropriate light distribution pattern may be emitted according to the situation.

Further, according to the vehicle headlamp 10C having the above configuration, since the light sources 401 and 402 are arranged to overlap in a front view of the vehicle headlamp 10C, the appearance of the vehicle headlamp 10C in a front view may be improved.

Further, according to the vehicle headlamp 10C having the above configuration, the light sources 401 and 501 are turned ON during high beam lighting, and the light sources 401 and 402 are turned ON during low beam lighting. For example, the light source 402 is turned ON during low beam lighting, but is turned OFF during high beam lighting. In this way, since the ON/OFF states of the light source 402 are independent from the ON/OFF states of the light source 401, the vehicle headlamp 10C may form an appropriate light distribution pattern depending on the situation.

Further, according to the vehicle headlamp 10C having the above configuration, since the fourth optical member 400 includes the shade 405, it is possible to prevent light emitted from the light sources 401 and 402 from being emitted in unintended directions.

### Second Example of Third Embodiment

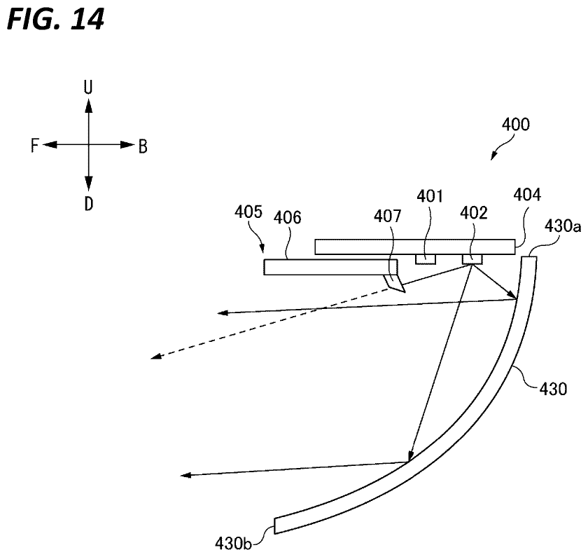

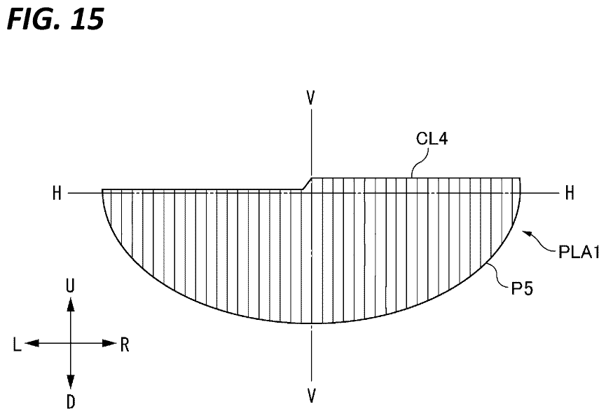

Next, a low beam light distribution pattern PLA1 in a second example of the third embodiment will be described with reference to FIGS. 14 and 15. In the present embodiment, the same parts as those in the first example of the third embodiment are described using the same reference numerals, and descriptions of duplicate parts are omitted as appropriate. This example differs from the first example of the third embodiment in that only the light source 402 is turned ON during low beam lighting. In this example as well, it is assumed that the vehicle 1C is traveling in the right lane. Further, in this example as well, the light sources 401 and 402 may be individually controlled by the lamp control unit 60.

The low beam light distribution pattern PLA1 during low beam lighting in this example will be described with reference to FIGS. 14 and 15. When the driver of the vehicle 1C operates the light switch 40 to emit the low beam light distribution pattern PLA1, the light source 402 emits light toward the reflector 430, as illustrated in FIG. 14. In the meantime, the light source 401 does not emit light toward the reflector 430. Therefore, the low beam light distribution pattern PLA1 illustrated in FIG. 15 is projected onto a virtual vertical screen at a predetermined position in front of the vehicle 1C. For example, in the present embodiment, the low beam light distribution pattern PLA1 is formed by the fifth light distribution pattern P5. For example, the light source 402 is turned ON and the light sources 401 and 501 are turned OFF during low beam lighting.

As in the first example of the third embodiment, the fourth light distribution pattern P4 is sharp, whereas the fifth light distribution pattern P5 is blurred overall. Therefore, the fourth cutoff line CL4 of the fifth light distribution pattern P5 (i.e., the cutoff line of the low beam light distribution pattern PLA1) appears blurred.

The high beam light distribution pattern PH1 during high beam lighting in this example is the same as the high beam light distribution pattern PH1 during high beam lighting in the first example of the third embodiment. For example, in this example, when the driver of the vehicle 1C operates the light switch 40 to emit the high beam light distribution pattern PH1, the high beam light distribution pattern PH1 illustrated in FIG. 13 is projected onto a virtual vertical screen at a predetermined position in front of the vehicle 1C. Accordingly, in this example, both the light sources 401 and 501 are turned ON, and the light source 402 is turned OFF during high beam lighting.

In this example as well, the vehicle headlamp 10C exerts the same effects as those in the first example of the third embodiment.

Further, according to the vehicle headlamp 10C having the above configuration, the light sources 401 and 501 are turned ON during high beam lighting, and the light source 402 is turned ON during low beam lighting. For example, the light source 402 is turned ON during low beam lighting, but is turned OFF during high beam lighting. In this way, since the ON/Off states of the light source 402 are independent from the ON/OFF states of the light source 401, the vehicle headlamp 10C may form an appropriate light distribution pattern depending on the situation.

### Modification of Third Embodiment

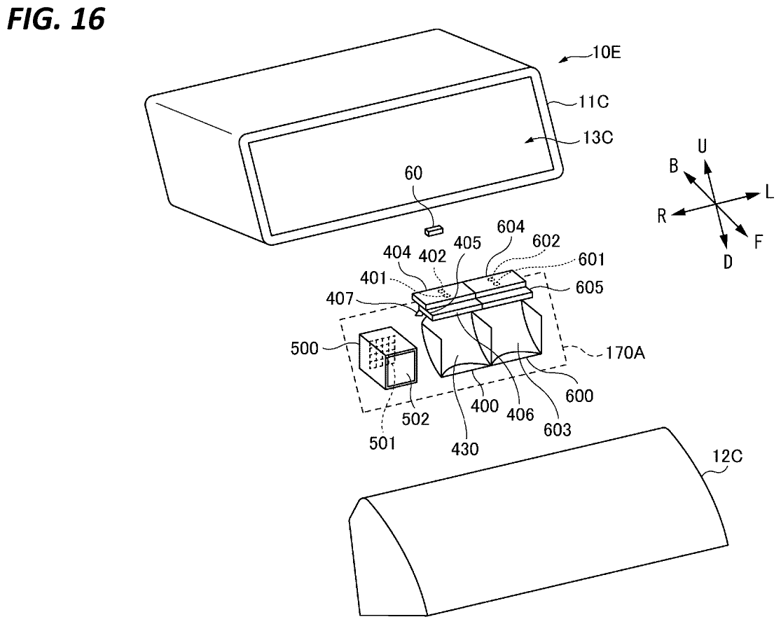

Next, a vehicle headlamp 10E according to a modification of the third embodiment will be described with reference to FIG. 16. The vehicle headlamp 10E includes the lamp control unit 60 and an optical module 170A. The optical module 170A includes the fourth optical member 400, the fifth optical member 500, and a sixth optical member 600.

The sixth optical member 600 is arranged to come into contact with the left side of the fourth optical member 400. However, for example, the sixth optical member 600 may be arranged at the right side, above, or below the fourth optical member 400. For example, the fourth optical member 400 and the sixth optical member 600 may be arranged side by side or one above another. Further, the sixth optical member 600 may, for example, be arranged separately from the fourth optical member 400.

The sixth optical member 600 includes a light source 601 (e.g., a third light source), a light source 602 (e.g., a fourth light source), a reflector 603, a substrate 604, and a shade 605. The light sources 601 and 602 are installed on the substrate 604. The configuration of the light source 601, light source 602, reflector 603, substrate 604, and shade 605 included in the sixth optical member 600 may be the same as the configuration of the light source 401, light source 402, reflector 430, substrate 404, and shade 405 included in the fourth optical member 400.

The optical module 170A forms the low beam light distribution pattern PL1 by emitting light from the fourth optical member 400 and the sixth optical member 600. Therefore, even when the intensity (luminous intensity) of light emitted from the fourth optical member 400 according to this modification is lower than the intensity of light emitted from the fourth optical member 400 according to the first example of the third embodiment, a suitable low beam light distribution pattern PL1 may still be formed. For example, even when the light source provided in the fourth optical member 400 is not a high-intensity light source, the optical module 170A may still form a suitable low beam light distribution pattern PL1.

The vehicle headlamp 10E according to this example also exhibits the same effects as the vehicle headlamp 10C.

The above embodiments have described cases where the vehicles 1, 1A and 1C are traveling in the right lane, but the present disclosure may also be applied to cases where the vehicles 1, 1A and 1C are traveling in the left lane.

The above embodiments have described cases where the preceding vehicles 1B and 1D are present in front of the vehicles 1, 1A and 1C, but the present disclosure may also be applied to cases where oncoming vehicles are present in front of the vehicles 1, 1A and 1C.

In the first embodiment, the modification of the first embodiment, and the second embodiment, the first optical members 100 and 100A are parabolic optical members, but may instead be, for example, PES-type optical members. For example, in the present embodiment, at least the second optical members 200 and 200A may be parabolic optical members.

In the first embodiment, the modification of the first embodiment, and the second embodiment, the first optical member 100 includes the first member 110 and the second member 120, but may include only one of them.

In the first embodiment, the modification of the first embodiment, and the second embodiment, the second optical member 200 is turned OFF during high beam lighting, but may instead be dimmed. For example, during high beam lighting, the first optical member 100 and the third optical member 300 may be turned ON while the second optical member 200 is dimmed.

In the first embodiment, the modification of the first embodiment and the second embodiment, the second light distribution pattern P2 overlaps the entire first cutoff line CL1, but may overlap only a portion of the first cutoff line CL1.

In the above embodiments, the lamp control unit 60 is installed in the vehicle headlamps 10, 10A, 10C and 10E, but the lamp control unit 60 may instead be installed in the vehicles 1, 1A and 1C rather than in the vehicle headlamps 10, 10A, 10C and 10E. For example, the lamp control unit 60 may be integrated into the vehicle control unit 50.

In the above embodiments, the camera 30 is installed in the vehicles 1, 1A and 1C, the camera 30 may be installed in the vehicle headlamps 10, 10A, 10C and 10E rather than in the vehicles 1, 1A and 1C.

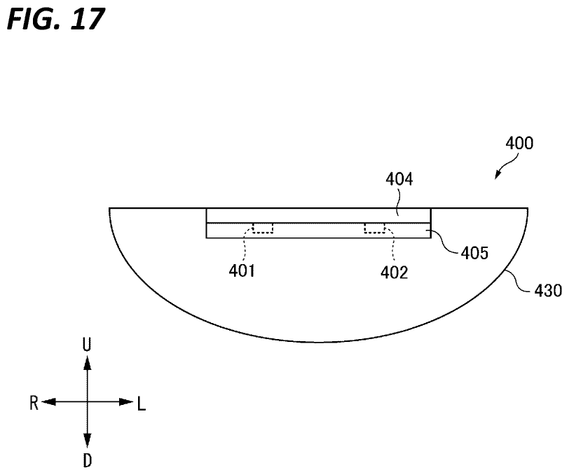

In the first example of the third embodiment, the second example of the third embodiment, and the modification of the third embodiment, the light sources 401 and 402 are arranged to overlap in a front view, but they may also be arranged not to overlap. For example, as illustrated in FIG. 17, the light source 401 may be located at the right side of the light source 402 in a front view. However, the light source 401 may also be located at the left side of the light source 402 in a front view.

In the first example of the third embodiment, the second example of the third embodiment, and the modification of the third embodiment, the light source 402 is turned OFF during high beam lighting, but it may be dimmed instead. For example, during high beam lighting, the light sources 401 and 501 may be turned ON while the light source 402 is dimmed.

In the first example of the third embodiment, the second example of the third embodiment, and the modification of the third embodiment, the fourth optical member 400 includes the shade 405, but it may also be configured without the shade 405. Further, in the modification of the third embodiment, the sixth optical member 600 includes the shade 605, but it may also be configured without the shade 605.

In the first example of the third embodiment, the second example of the third embodiment, and the modification of the third embodiment, the reflector 430 has stepped surfaces configured to emit light from the light source 401 and/or the light source 402 to a desired position, but the present disclosure is not limited to this. The stepped surfaces of the reflector 430 need not be configured to emit light from the light source 401 and/or the light source 402 to a desired position. In this case, the shade 405 is configured such that light emitted from the light source 401 and/or the light source 402 is emitted to a desired position. When the fourth optical element 400 includes the shade 405, the vehicle headlamps 10C and 10E may emit a desired light distribution pattern even when using the reflector 430 of a simplified configuration. Furthermore, in the modification of the third embodiment, the stepped surfaces of the reflector 430 may also not be configured to emit light from the light source 601 and/or the light source 602 to a desired position. In this case, the shade 605 is configured such that light emitted from the light source 601 and/or the light source 602 is emitted to a desired position. When the fourth optical element 400 includes the shade 405 and the sixth optical element 600 includes the shade 605, the vehicle headlamp 10E may emit a desired light distribution pattern even when the reflectors 430 and 603 of a simple configuration are used.

In the first example of the third embodiment, the second example of the third embodiment, and the modification of the third embodiment, the entire fourth cutoff line CL4 is more blurred than the third cutoff line CL3, but only a portion of the fourth cutoff line CL4 may be made more blurred than the third cutoff line CL3.

As described above, this specification discloses the following.
(1) A vehicle headlamp comprising:
a first optical member having a first cutoff line and configured to form a first light distribution pattern by irradiating at least a region below the first cutoff line with light; and
a second optical member having a second cutoff line that is more blurred than the first cutoff line and configured to form a second light distribution pattern that is emitted to a position overlapping at least a portion of the first cutoff line,
wherein the second optical member includes a second light source and a second reflector having a parabolic shape configured to reflect light emitted from the second light source forward of the vehicle headlamp.
(2) The vehicle headlamp described in (1), wherein the first optical member includes a first light source and a first reflector having a parabolic shape configured to reflect light emitted from the first light source forward of the vehicle headlamp.
(3) The vehicle headlamp described in (1) or (2), wherein the first optical member and the second optical member are configured as a single optical unit.
(4) The vehicle headlamp described in any one of (1) to (3), further comprising: a third optical member configured to irradiate a region including at least a region above the first cutoff line with light, and to dim any region within that region,
wherein during high beam lighting, both the first optical member and the third optical member are turned ON, or both the first optical member and the third optical member are turned ON while the second optical member is dimmed, and
during low beam lighting, the first optical member and the second optical member are turned ON.
(5) A vehicle headlamp comprising:
a first optical member having a first cutoff line and configured to form a first light distribution pattern by irradiating at least a region below the first cutoff line with light; and
a second optical member having a second cutoff line that is more blurred than the first cutoff line and configured to form a second light distribution pattern that is emitted to a position overlapping at least a portion of the first cutoff line,
wherein the second optical member includes a second light source and a second reflector having a parabolic shape configured to reflect light emitted from the second light source forward of the vehicle headlamp, and
the first optical member and the second optical member are arranged in a height direction of a vehicle on which the vehicle headlamp is mounted, and
the second optical member is arranged above the first optical member.
(6) The vehicle headlamp described in (5), wherein the first optical member includes a plurality of first reflectors, and
the plurality of first reflectors are arranged in the height direction of the vehicle on which the vehicle headlamp is mounted.
(7) The vehicle headlamp described in (6), wherein the plurality of first reflectors are arranged in a linear manner.
(8) The vehicle headlamp described in any one of (5) to (7), wherein when another vehicle is present in at least a part of an irradiation region of the second light distribution pattern, no light is emitted from the second light source.
(9) A vehicle headlamp comprising:
a reflector having a parabolic shape;
a third light source configured to emit a fourth light distribution pattern having a third cutoff line; and
a fourth light source configured to emit a fifth light distribution pattern having a fourth cutoff line located above the third cutoff line, at least a portion of the fourth cutoff line being more blurred than the third cutoff line,
wherein the third light source is located at a focal point of the reflector, and
wherein the fourth light source is located behind the third light source.
(10) The vehicle headlamp described in (9), wherein the third light source and the fourth light source are configured to be individually turned ON and OFF.
(11) The vehicle headlamp described in (9) or (10), wherein the third light source and the fourth light source are arranged to overlap each other in a front view of the vehicle headlamp.
(12) The vehicle headlamp described in any one of (9) to (11), further comprising:
a fifth light source configured to irradiate a region including a region above the third cutoff line with light, and to dim any region within that region,
wherein during high beam lighting, the third light source and the fifth light source are turned ON, or the third light source and the fifth light source are turned ON while the fourth light source is dimmed, and
wherein during low beam lighting, the fourth light source is turned ON, or both the third light source and the fourth light source are turned ON.
(13) The vehicle headlamp described in any one of (9) to (12), further comprising:
a shade configured to block a portion of light emitted from the third light source and the fourth light source.
(14) The vehicle headlamp described in any one of (9) to (13), further comprising:
a shade configured to block light emitted from the third light source and the fourth light source that is not directed toward the reflector.

From the foregoing, it will be understood that various examples of the present disclosure are described for illustrative purposes, and that various variations may be made without departing from the scope and idea of the present disclosure. Therefore, the various examples disclosed herein are not intended to limit the essential scope and ideas designated by each of the following claims.

What is claimed is:

1. A vehicle headlamp comprising:
a first optical element having a first cutoff line and configured to form a first light distribution pattern by irradiating at least a region below the first cutoff line with light; and
a second optical element having a second cutoff line that is more blurred than the first cutoff line and configured to form a second light distribution pattern that is emitted to a position overlapping at least a portion of the first cutoff line,
wherein the second optical element includes a second light source and a second reflector having a parabolic shape configured to reflect light emitted from the second light source forward of the vehicle headlamp.

2. The vehicle headlamp according to claim 1, wherein the first optical element includes a first light source and a first reflector having a parabolic shape configured to reflect light emitted from the first light source forward of the vehicle headlamp.

3. The vehicle headlamp according to claim 1, wherein the first optical element and the second optical element are configured as a single optical unit.

4. The vehicle headlamp according to claim 1, further comprising:
a third optical element configured to irradiate a region including at least a region above the first cutoff line with light, and to dim any region within that region,
wherein during high beam lighting, both the first optical element and the third optical element are turned ON, or both the first optical element and the third optical element are turned ON while the second optical element is dimmed, and
during low beam lighting, the first optical element and the second optical element are turned ON.

5. A vehicle headlamp comprising:
a first optical element having a first cutoff line and configured to form a first light distribution pattern by irradiating at least a region below the first cutoff line with light; and
a second optical element having a second cutoff line that is more blurred than the first cutoff line and configured to form a second light distribution pattern that is emitted to a position overlapping at least a portion of the first cutoff line,
wherein the second optical element includes a second light source and a second reflector having a parabolic shape configured to reflect light emitted from the second light source forward of the vehicle headlamp, and
the first optical element and the second optical element are arranged in a height direction of a vehicle on which the vehicle headlamp is mounted, and
the second optical element is arranged above the first optical element.

6. The vehicle headlamp according to claim 5, wherein the first optical element includes a plurality of first reflectors, and
the plurality of first reflectors are arranged in the height direction of the vehicle on which the vehicle headlamp is mounted.

7. The vehicle headlamp according to claim 6, wherein the plurality of first reflectors are arranged in a linear manner.

8. The vehicle headlamp according to claim 5, wherein when another vehicle is present in at least a part of an irradiation region of the second light distribution pattern, no light is emitted from the second light source.

9. A vehicle headlamp comprising:
a reflector having a parabolic shape;
a third light source configured to emit a fourth light distribution pattern having a third cutoff line; and
a fourth light source configured to emit a fifth light distribution pattern having a fourth cutoff line located above the third cutoff line, at least a portion of the fourth cutoff line being more blurred than the third cutoff line,
wherein the third light source is located at a focal point of the reflector, and
wherein the fourth light source is located behind the third light source.

10. The vehicle headlamp according to claim 9, wherein the third light source and the fourth light source are configured to be individually turned ON and OFF.

11. The vehicle headlamp according to claim 9, wherein the third light source and the fourth light source are arranged to overlap each other in a front view of the vehicle headlamp.

12. The vehicle headlamp according to claim 9, further comprising:
a fifth light source configured to irradiate a region including a region above the third cutoff line with light, and to dim any region within that region,
wherein during high beam lighting, the third light source and the fifth light source are turned ON, or the third light source and the fifth light source are turned ON while the fourth light source is dimmed, and
wherein during low beam lighting, the fourth light source is turned ON, or both the third light source and the fourth light source are turned ON.

13. The vehicle headlamp according to claim 9, further comprising:
a shade configured to block a portion of light emitted from the third light source and the fourth light source.

14. The vehicle headlamp according to claim 9, further comprising:
a shade configured to block light emitted from the third light source and the fourth light source that is not directed toward the reflector.
